(19) United States
(12) Patent Application Publication
(10) Pub. No.: US 2025/0303683 A1
(43) Pub. Date: Oct. 2, 2025

(54) Cellulose-Based Packaging Materials with Enhanced Barrier Properties

(71) Applicant: WiSys Technology Foundation, Inc., Madison, WI (US)

(72) Inventors: Roland Gong, Plover, WI (US); Adam Schmidt, Appleton, WI (US)

(73) Assignee: WiSys Technology Foundation, Inc., Madison, WI (US)

(21) Appl. No.: 19/098,606

(22) Filed: Apr. 2, 2025

Related U.S. Application Data
(60) Provisional application No. 63/572,986, filed on Apr. 2, 2024.

(51) Int. Cl. B32B 29/00; B32B 5/06; B32B 29/02; D21F 11/00; D21F 11/04

(52) U.S. Cl. CPC B32B 29/002; B32B 5/067; B32B 29/02; D21F 11/002; D21F 11/04; B32B 2250/02; B32B 2262/062; B32B 2266/02; B32B 2307/7244; B32B 2307/7376; B32B 2317/18; B32B 2386/00

(57) ABSTRACT

A cellulose-based packaging material has a multi-layer structure that includes a barrier layer with at least one of microfibrillated cellulose (MFC) and cellulose nanofibril (CNF) that provides enhanced moisture and/or oxygen or other gas barrier properties. The other layers, e.g., outer layers, of the material's multilayer structure may be cellulose-based and the entire material may be devoid of polymeric or metallic films or foils. The material may be implemented as a sandwich structure with an interior MFC and/or CNF film as the barrier layer and cellulose-based outer layers that immobilize the MFC and/or CNF film during the material's dewatering and drying procedures. Nano-scale cellulose products delivering the MFC and/or CNF may be incorporated into a foamed MFC and/or CNF product upstream of a paper machine headbox, so that the headbox(es) receives a volume of foamed MFC and/or CNF product for forming the barrier layer and at least two volumes of non-foamed and non-MFC and/or CNF cellulose-based feedstock for forming the outer layers.

### CROSS REFERENCE TO RELATED APPLICATION

This application claims the benefit of U.S. provisional application 63/572,986 filed Apr. 2, 2024 and is hereby incorporated by reference.

### STATEMENT REGARDING FEDERALLY SPONSORED RESEARCH OR DEVELOPMENT

--

### FIELD OF THE INVENTION

The present invention relates to packaging material and, in particular, to a cellulose-based packaging material and method of making the cellulose-based packaging material using a paper machine.

### BACKGROUND OF THE INVENTION

Some packaging materials have enhanced moisture and oxygen or other gas barrier properties. Packages that include these barrier-type materials are typically used to store products that benefit from dry or odor-mitigating storage, such as dry foods, candy, cigarettes, or the like. Some packaging materials are made entirely from substrates that themselves have suitable moisture and/or gas barrier characteristics, such as various petroleum or bio-based polymeric materials. However, some polymeric materials have limited recyclability, poor biodegradability, and therefore limited sustainability compared to other packaging materials.

Efforts to improve sustainability of packaging materials include implementing paper-type substrates made from cellulose-based materials such as wood-based or other plant-based fiber stock. However, these materials themselves may not have adequate barrier properties for certain packaging implementations due to gaps or voids in their structure(s) that provide high moisture and gas transmissibility characteristics. To overcome such deficiencies, paper or cellulosed-based substrates are typically combined with non-paper or non-cellulose-based substrates as barrier layers to create packaging materials. Procedures such as coating, laminating, or adhering can be used to combine paper substrates with, for example, polymeric and/or metallic films or foils or other structures as barrier layers. However, incorporating such barrier layers increases costs and requires less sustainable raw materials. This contrasts with pressures on the packaging industry to reduce the usage of non-sustainable packaging raw materials, especially plastic films.

Attempts have been made to enhance barrier characteristics of paper substrates using sustainable cellulose-based fiber stock or feedstock. Micro- and nano-scale cellulose products such as microfibrillated cellulose (MFC) and nanofibrillated cellulose (NFC) also called cellulose nanofibril (CNF) can provide improved barrier characteristics compared to other cellulose products. However, implementing MFC and/or CNF as moisture and/or gas barriers in packaging materials has proven challenging.

Various attempts have been made to coat paper or paperboard using known coating processes. However, using known surface coating methods to apply MFC and/or CNF onto paper or paperboard has been proven ineffective. Drying methods associated with known surface coating methods cannot dry the product effectively because both MFC and CNF products contain such a large amount of water content. For example, CNF typically has a solid percentage of only about 1%. Even if the coated product is properly dried with such known drying methods, the resultant coating typically includes cracks and pinholes which compromises the coating's integrity as a barrier.

Other attempts have been made to try to minimize the formation of cracks by using more of the functional components MFC and/or CNF (e.g., at least 15 gsm, or grams per square meter, of MFC or CNF). Although the problems of crack and pinhole formation may be reduced by substantial increases in the amount of functional components MFC and/or CNF, such problems still remain and other associated downsides are presented. Using more MFC and/or CNF renders the processes' dewatering procedure less effective and results in higher cost.

Overall, the existing products decrease the dewatering performance and/or increase the costs of raw materials and manufacturing.

### SUMMARY OF THE INVENTION

The present invention seeks to improve upon existing materials and methods of producing continuous films from micro-and nano-scale cellulose for use in packaging materials. The present invention solves the current issues noted below using existing raw materials MFC and/or CNF to produce packaging products for the paper industry.

First, the present invention solves the problem of distributing a low basis weight of MFC and CNF (e.g., about 5 gsm, or gram per square meter) evenly on a paper matrix. This can be achieved using an applicator over the paper machine's wet end via a foam-forming method.

Second, the present invention solves the problem of immobilizing MFC and/or CNF in later dewatering and drying processes to avoid cracks and pinholes. This can be achieved using a sandwich structure with layers of paper matrix sandwiching the MFC and/or CNF inner layer.

The present invention defines a new paper product containing MFC, CNF, or both, and which provides an excellent gas barrier for multiple packaging applications at a very competitive cost. The gas and aroma barrier will extend the product's shelf life without using plastic films and foils. If packaging material require a moisture barrier, the new paper product combines with petrol-or bio-based polymers using extrusion coating and/or lamination techniques.

The applications of the packaging products can be found in many current paper-based packaging materials which require O₂ and aroma barriers, such as many dry foods, candy, cigarettes, and the like. It can be used for liquid packaging (e.g., milk and beverages) when combined with other materials via the regular converting processes. It will reduce the consumption of plastic films and foils and has the potential to reduce the fiber consumption of packaging using MFC and CNF as reinforcement materials.

Specifically, according to one aspect of the invention, the cellulose-based packaging material includes a multi-layer structure with a moisture and/or gas barrier layer made from MFC and/or CNF. The other layers, e.g., outer or exterior layers, of the material's multilayer structure may be cellulose-based and the entire material may be devoid of polymeric or metallic films or foils.

It is thus a feature of at least one embodiment of the invention to provide a packaging material made from only sustainable or renewable materials that has sufficient moisture and gas barrier characteristics for dry or odor-mitigating storage of its enclosed product(s).

In accordance with another aspect of the invention, paper outer layers support an interior continuous MFC and/or CNF film. Each outer paper outer layer may have an oxygen transmission rate (OTR) of greater than 1000 cm³/m²/day and the MFC and/or CNF film may have an OTR of less than 100 cm³/m²/day.

It is thus a feature of at least one embodiment of the invention to provide a packaging material with oxygen barrier performance made entirely from cellulose-based constituents.

In accordance with another aspect of the invention, the material may be implemented as a sandwich structure with an interior MFC and/or CNF film as the barrier later and cellulose-based outer layers that immobilize the MFC and/or CNF film during the material's dewatering and drying procedures. Nano-scale cellulose products delivering the MFC and/or CNF may be incorporated into a foamed MFC and/or CNF product upstream of a paper machine headbox, so that the headbox(es) receives a volume of foamed MFC and/or CNF product for forming the barrier layer and at least two volumes of non-foamed and non-MFC and/or CNF cellulose-based stock material or feedstock for forming the outer layers.

It is thus a feature of at least one embodiment of the invention to produce cellulose-based packaging materials with enhanced barrier properties that can be produced in conventional paper machines, such as a hybrid Foundrinier paper machine.

These particular objects and advantages may apply to only some embodiments falling within the claims and thus do not define the scope of the invention.

### BRIEF DESCRIPTION OF THE DRAWINGS

FIG. 1 is a schematic representation of a portions of a hybrid paper machine of the present invention used to receive stock material and to remove water content for forming a paper product;

FIG. 2 is a cross-sectional view of the stock material in a three-ply sandwich structure arrangement at a paper machine's wet end used to form a paper product without cracking or creating pinholes;

FIG. 3 is a schematic representation of portions of a variant of the hybrid paper machine of FIG. 1; and

FIG. 4 is a cross-sectional view of the paper product incorporating a cellulose-based barrier film.

### DETAILED DESCRIPTION OF THE PREFERRED EMBODIMENT

A cellulose-based packaging material is provided with enhanced barrier properties. To obtain a good O₂ and aroma barrier property, MFC and/or CNF of the packaging material must (1) form a continuous film during forming (i.e., forming a sheet) and (2) endure multiple stages of dewatering (i.e., filtration, vacuum, pressing and drying) without cracking or forming pinholes. By overcoming these two hurdles, the present invention can not only produce a continuous barrier film, e.g., within a cellulose-based packaging material, but also help to reduce the amount (or cost) of MFC and CNF. In addition, the new paper product will present a high mechanical strength because of the MFC and CNF content or reinforced components.

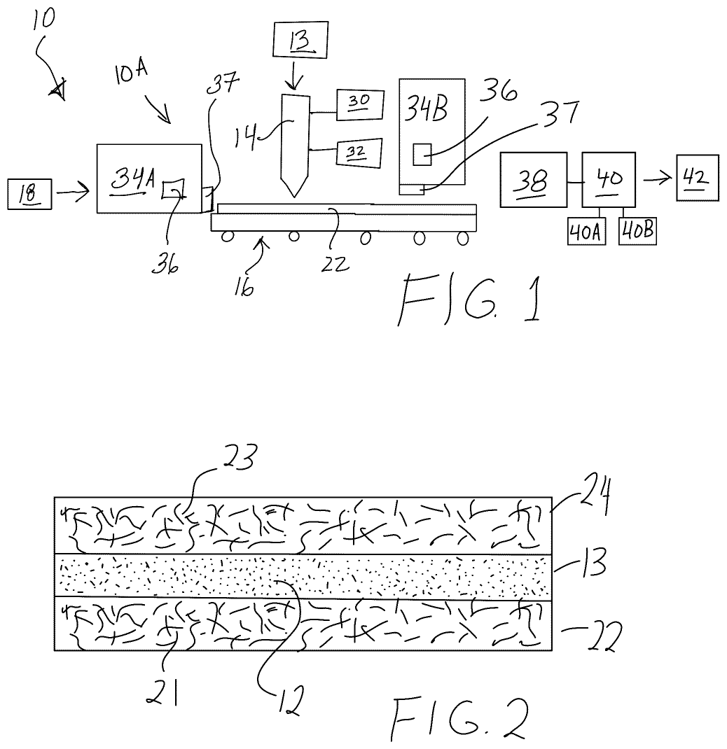

Referring to FIG. 1, the cellulose-based packaging material is made at a facility such as a paper mill on a paper machine 10. Paper machine 10 is shown as a hybrid Fourdrinier paper machine or hybrid paper machine 10A. The hybrid paper machine 10A is a device for producing paper with a wet end consisting of a moving endless belt of wire or plastic screen that receives a mixture of pulp and water and allows excess water to drain off, forming a continuous sheet for further drying by suction, pressure, and heat. Calenders (rollers or plates) smooth the paper or board and impart gloss or other desired finish to the surface.

Generally, the hybrid paper machine 10A is used for water removal, taking solid content from about 1% to greater than 90%. The resulting fiber web is compressed and dried by the hybrid paper machine 10A. Specifically in the present invention, the hybrid paper machine 10A is used to remove water content from an aqueous fiber foam 13 containing MFC and/or CNF 12 thickened by dewatering. The resulting fiber web is compressed and dried by the hybrid paper machine 10A.

The hybrid paper machine 10A includes a headbox or headboxes 34A, 34B, receiving a feedstock or stock material 18 before the forming, drying, and finishing processes begin. The headbox assures a uniform distribution of stock material 18 flows across the hybrid paper machine 10A and provides velocity control of the jets leaving the headbox(es) 34A, 34B. The headbox(es) 34A, 34B includes single or multiple stage(s) turbulence generator 36 which produces a uniform stock material to converge at an outlet opening or orifice 37.

The stock material 18 is an aqueous cellulose-based pulp slurry. The aqueous fiber foam 13 is formed by slushing the MFC and/or CNF 12 with water to produce a slurry. The aqueous fiber foam 13 of MFC and/or CNF 12 is then created using a foaming agent and high intensity mixing of the slurry and/or a foam generator. The MFC and/or CNF 12 is thus uniformly distributed onto and/or trapped within the small foams of the aqueous fiber foam 13. Known foaming and mixing devices may be used to produce the aqueous fiber foam 13.

The stock material 18 is received by the headbox(es) 34A, 34B and further delivered to the wet end 16 or forming section of the hybrid paper machine 10A as further described below.

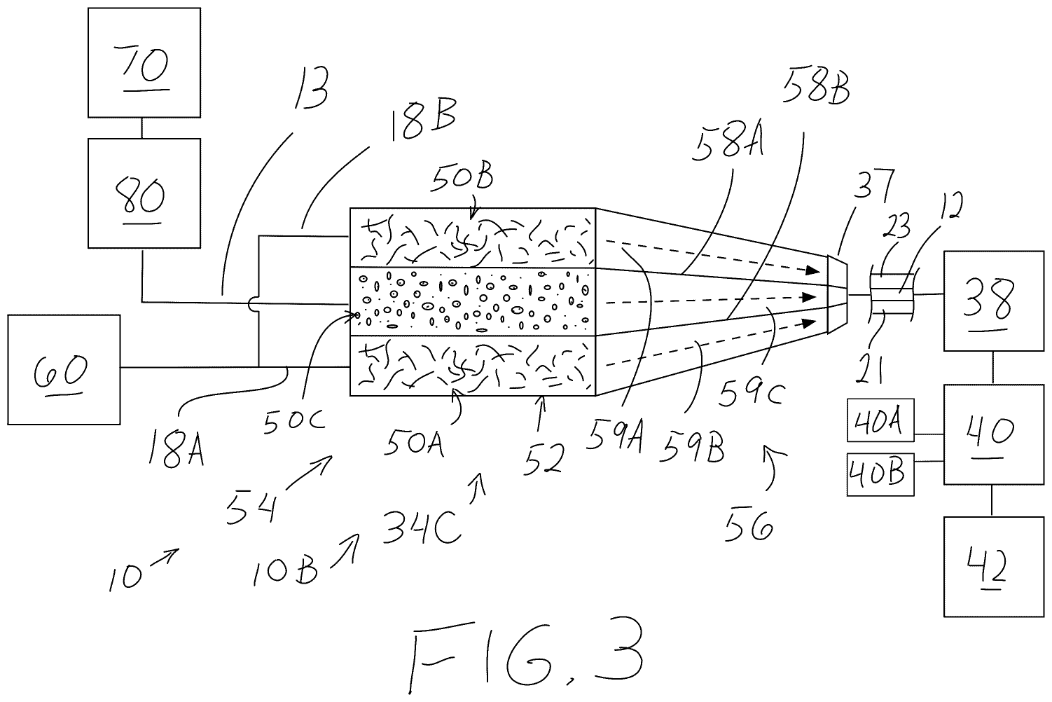

Referring now to FIGS. 1 and 2, hybrid paper machine 10A (FIG. 1) may include a wet end applicator 14 (FIG. 1) over the paper machine's wet end 16 (FIG. 1) to distribute a low basis weight (e.g., about 5 gsm, or less than 5 gsm) of aqueous fiber foam 13 containing MFC and/or CNF 12 (FIG. 2) evenly onto a bottom layer of stock material's 18 cellulose fibers 21 that provide paper web 22 (FIG. 2) from headbox 34A. The aqueous fiber foam 13 is delivered between the upstream and downstream headboxes 34A, 34B. The top layer of cellulose fibers 23 that define paper web 24 (FIG. 2) is then formed over the aqueous fiber foam 13 with the second headbox 34B to form a multilayered packaging material 19 (FIG. 2) with a three ply sandwich structure 20 (FIG. 2).

Normally, the foam-forming technique is detrimental to the MFC and/or CNF 12 distribution over a bottom layer of regular paper web. However, referring now to FIG. 2, this implantation traps the MFC and/or CNF 12 within the aqueous fiber foam 13 and sandwiches the inner layer between the bottom and top layers of paper webs 22, 24. Thus, the third ply of regular paper web 24 from the second or downstream headbox 34B is placed on top of the functional inner layer of MFC and/or CNF 12 within the aqueous fiber foam 13 to form the sandwich structure.

Still referring to FIG. 2, the MFC and/or CNF 12 of the aqueous fiber foam 13 are composed of the same cellulose fibers 21, 23 as the paper webs 22, 24, only with substantially different fiber sizes, so the layers bond tightly due to their high cellulose affinity to each other (i.e., strong bonds). Combining cellulose fibers of MFC and/or CNF 12 with cellulose fibers of the paper webs 22, 24 includes both physical entanglement and chemical bonding by way of hydrogen bonding of respective hydroxyl groups of the respective fibers of small MFC and/or CNF 12 and the large conventional or non-MFC and/or CNF fibers 21, 22.

Referring again to FIG. 1, wet end applicator 14 may include an applicator 30 and suitable foaming and pumping devices 32 to form the sandwich sheet structure 20 at the wet end 16 after the stock material 18 exits the headbox(es) 34A, 34B. The sandwich sheet structure 20 then continues to the processes of filtration, vacuum, pressing, drying, and finishing on the hybrid paper machine 10, as further described below.

Still referring to FIG. 1, hybrid paper machine 10A may further include additional filtration and vacuum elements 38 which consists of, e.g., hydrofoils, breast roll, couch roll, suction boxes, wire rolls and other parts which are commonly found in Fourdrinier paper machines. These filtration and vacuum elements 38 use negative pressure (vacuums) to drain and remove water from the sandwich sheet structure 20. The wet end 16 immobilizes the MFC and/or CNF 12 within the sandwich structure for later dewatering and drying processes by the hybrid paper machine 10 to avoid cracks and pinholes.

Next, dewatering arrangement 40 with various drying elements such as wet press 40A of the hybrid paper machine 10 may be used to mechanically press or squeeze water from the sandwich sheet structure 20 and dryer 40B to dry the sandwich sheet structure 20 by evaporation, thus increasing the solid content of the sandwich sheet structure 20 and reducing the water content and thickness of the sandwich sheet structure 20 to further assist with the bonding of cellulose fibers. The three plies of the sandwich sheet structure 20 are made of cellulose fibers so that they form a single solid sheet or film 42 due to the high cellulose affinity between layers.

If the solid sheet or film 42 requires a moisture barrier, the sandwich sheet structure 20 may be further combined with petrol-or bio-based polymers using extrusion coating and/or lamination techniques in final finishing steps.

It is thus a feature of the present invention to utilize the formation of a three ply sandwich structure at the wet end 16 of the hybrid paper machine 10 to produce a paper sheet product or film 42 without cracking or pinhole formation in later dewatering and drying steps. A low basis weight of MFC and/or CNF 12 is distributed within the three ply sandwich structure to reduce the material cost and to encourage cellulose affinity between the paper and MFC and/or CNF 12 layer.

Elements of the Fourdrinier paper machine which may be used with the present invention are as described in U.S. Pat. No. 9,951,471 entitled “Method and machine for manufacturing paper products using fourdrinier forming”; U.S. Pat. No. 1,928,286 entitled “Fourdrinier paper machine”; and at <https://en.wikipedia.org/wiki/Paper_machine>, hereby incorporated by reference.

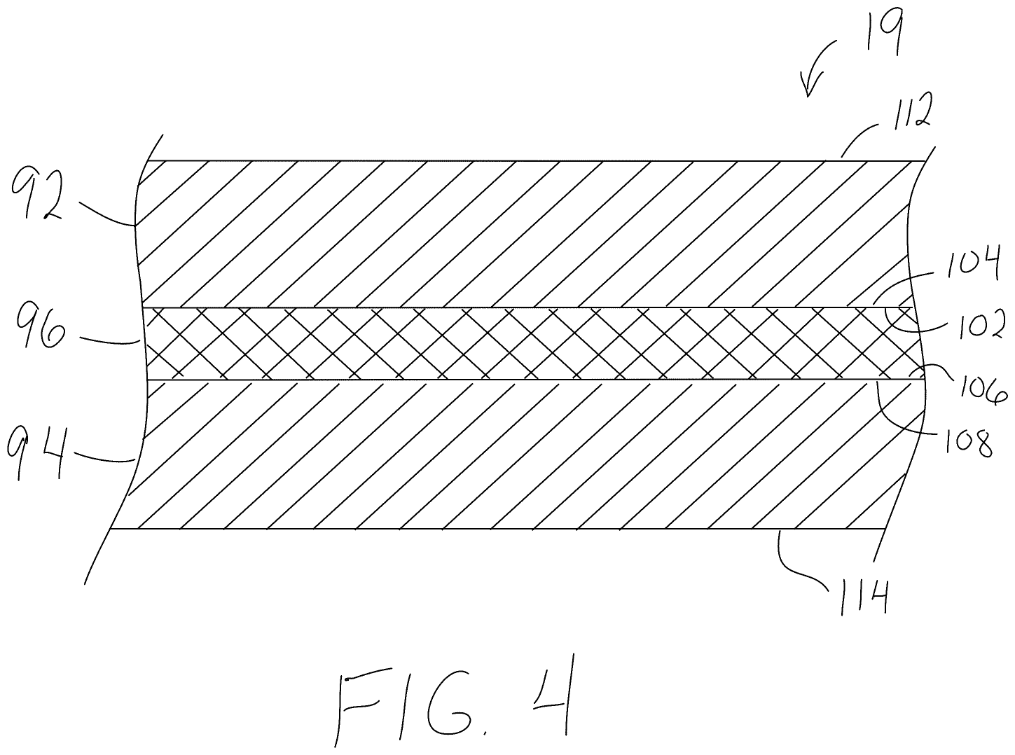

Referring now to FIG. 3, paper machine 10 is shown as hybrid paper machine 10B, which is a variant of hybrid paper machine 10A of FIG. 1, with those descriptions applying here as well. Hybrid paper machine 10B includes a stratified headbox or multiple layer headbox with multiple headbox compartments 50A, 50B, 50C that are configured to hold respective volumes of cellulose-based feedstocks for forming different constituents or layers of the cellulose-based packaging material. The headbox compartments 50A, 50B, 50C may be defined by separate headboxes 34A, 34B as shown in FIG. 1 or may be defined within a single, e.g., stratified, multiple layer, multicompartment, or multilayer headbox headbox 34C as shown in FIG. 3, which is typically suitable for a high-speed paper machine 10. Multilayer headbox 34C includes a housing 52 with inlet and outlet segments 54, 56. Compartments 50A, 50B, 50C are defined within the multilayer headbox housing's inlet segment 54. Outlet segment 56 defines outer walls that may taper downwardly toward the hybrid paper machine's 10B forming section or wet end 16 (FIG. 1). Layering vanes 58A, 58B are mounted within outlet segment 56 to provide separate flow passages 59A, 58B, 59C from headbox compartments 50A, 50B, 50C, through respective outlet openings or orifice(s) of outlet segment 56, for layered delivery onto, e.g., the former at wet end 16 (FIG. 1). An example of a suitable multilayer headbox 34A is a three-layer OptiFlo™ layering Fourdrinier headbox available from Valmet Oyj of Finland.

Still referring to FIG. 3, regardless of the particular configuration of headbox compartments 50A, 50B, 50C, each receives a volume of material from processing stations in the facility that are upstream of the hybrid paper machine wet end's 16 headbox 34C. Stock preparation station 60 typically includes, e.g., pulping machines or pulpers and cooperating components such as various ones of surge chests, machine chests, stuff boxes, selectifiers, refiners, primary and secondary cleaners, and basis weight controllers that process cellulose-based materials to form pulp that is delivered to headbox 34, 34A, 34B as stock material 18.

Still referring to FIG. 3, slurry station 70 typically includes a container that receives the MFC and/or CNF 12 and water and mixes them to form a slurry or aqueous suspension that is mostly water, e.g., typically at least 95 wt % of the slurry and a minor amount of MFC and/or CNF 12, e.g., typically 5 wt % or less of the slurry. The MFC and/or CNF 12 in the slurry may be from 0.5 wt %, or 1 wt %, or 1.5 wt %, or 2 wt %, or 2.5 wt % to 3 wt %, or 3.5 wt %, or 4.0 wt %, or 4.5 wt %, or 5 wt % of the slurry. Optional additives may also be present in a minor amount of, e.g, 5 wt % or less of the slurry. The optional additives may include retention aids such as cationic polymers that neutralize surface particle charge of MFC and/or CNF 12 (ionic in water) and allow fiber to combine before setting it on the base sheet such as paper web 22 (FIG. 2) to increase fiber retention. Suitable cationic polymers includes PAMs (polyacrylamides), PolyDADMAC Polydiallyldimethylammonium chloride), and polyamines.

Still referring to FIG. 3, foaming station 80 typically includes a container that receives the slurry and a foam generator such as a mechanical mixer and/or gas delivery system that can introduce gas into the slurry and form a dispersion of bubbles within the slurry. The foam's bubbles may range in size (diameter) from 10 micrometers to 1 millimeter. Fibers of the MFC and/or CNF 12 are confined within the bubbles of the foam. The foam provides a matrix of bubbles as a carrier medium that transports the fibers of MFC and/or CNF 12 (FIG. 2) in a substantially continuous concentration within the foamed slurry for delivery through the paper machine's wet end 16.

Still referring to FIG. 3, two volumes of paper pulp, which may be non-foamed and non-MFC and/or CNF cellulose-based stock material 18A, 18B, are delivered from stock preparation station 60 to respective compartments 50A, 50B of multilayer headbox 34. A volume of foamed MFC and/or CNF cellulose-based material as fiber foam 13 is delivered from foaming station 80 to compartment 50C of multilayer headbox 34. Multilayer headbox 34 delivers the stock material(s) 18A, 18B and fiber foam 13 in a layered arrangement, to the former or wet end 16 with the fiber foam 13 between the stock materials 18A, 18B for forming and dewatering. The interior fiber foam 13 layer typically has a greater moisture content or a lower wt % of solid materials compared to moisture content(s) of stock materials 18A, 18B. In some implementations, during dewatering, less vacuum may be applied with vacuum elements when fiber foam 13 is incorporated into the paper product compared to when only paper pulp (non-foamed and non-MFC and/or CNF cellulose-based stock material) is used for increasing fiber retention in of the fiber foam 13 applied to the former or wet end 16.

Referring now to FIG. 4 with background reference to FIG. 2, in this implementation, paper webs 22, 24 have been dried to form outer layers 92, 94 that provide exterior layers of the finished multilayer packaging material 19. Fiber foam 13 has been dried to form a film shown as barrier layer 96, sandwiched between paper outer layers 92, 94. This implementation shows barrier layers in direct face-to-face engagement or combined with outer layers 92, 94. An upper surface 102 of barrier layer 96 is shown engaging a lower surface 104 of outer layer 92. Lower surface 106 of barrier layer 96 is shown engaging an upper surface 108 of outer layer 104. Upper surface 112 of outer layer 92 defines a first exterior surface of packaging material 19 and lower surface 114 of outer surface 94 defines a second exterior surface of packaging material 19.

Still referring to FIG. 4, compared to paper outer layers 92, 94, the MFC and/or CNF film or barrier layer 96 typically has (i) fibers that are substantially smaller, (ii) a substantially lower basis weight, (iii) a substantially smaller cross-sectional thickness, and (iv) a substantially lower oxygen transmission rate (OTR). The MFC and/or CNF 12 (FIG. 2) fibers of barrier layer 96 have micro-scale and nan-scale dimensions. The MFC and/or CNF 12 (FIG. 2) fibers have at least one and typically (average) diameter and (average) length dimensions of less than 100 nm. Fibers of paper outer layers 92, 94 are larger by at least multiples and typically orders of magnitude, e.g., at least in (average) length dimension(s) than those of barrier layer 96 and correspond to typical fiber sizes of known paper products for packaging implementations.

Still referring to FIG. 4, the MFC and/or CNF 12 (FIG. 2) fibers provide barrier layer 96 with a basis weight of typically less than 15 gsm (grams per square meter) and more typically about 5 gsm. Barrier layer's 96 basis weight may be from 1 gsm, or 5 gsm, to 10 gsm, or 12 gsm. Barrier layer's 96 basis weight may be from 3.0 gsm, or 3.5 gsm, or 4.0 gsm or 4.5 gsm to 5.0 gsm, or 5.5 gsm, or 6.0 gsm, or 6.5 gsm, or 7.0 gsm. Gsm is determined according to ASTM D646.

Still referring to FIG. 4, the MFC and/or CNF 12 (FIG. 2) fibers may provide barrier layer 96 with a thickness that is less than, typically multiples times less than, respective thickness dimensions of outer layers 92, 94. In this configuration, within packaging material 19, outer layers 92, 94 may primarily provide (thicker) structural substrate(s) for the end-use package and barrier layer 96 may primarily provide a (thinner) film with barrier characteristics while providing supplemental structural integrity to the packaging material 19. Each outer layer 92, 94 may have a thickness dimension of a typical paper product, such as between 0.2 mm to 0.4 mm in thickness. In some implementations, barrier layer 96 may have a thickness between 0.05 mm to 0.2 mm. Barrier layer 96 may have a thickness from 0.05 mm, or 0.1 mm to 0.15 mm, or 0.2 mm.

Still referring to FIG. 4, the MFC and/or CNF 12 (FIG. 2) fibers may provide barrier layer 96 with an oxygen transmission rate (OTR) that is less than, typically multiples less than, respective OTRs of outer layers 92, 94. Each outer layer 92, 94 has an OTR that is greater than 1,000 cm³/m²/day, typically substantially greater than 100 cm³/m²/day and corresponding with OTRs of conventional fiber (non-MFC and/or CNF) uncoated paper products devoid of barrier films or foils. Barrier layer 96 typically has an OTR of 100 cm³/m²/day or less so that it may function as an oxygen or other gas barrier. Oxygen transmission rate (OTR) is measured in accordance with ASTM D3985. Typically, samples are tested at 23° C., 0% relative humidity (RH), 50 cm² sample size.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What we claim is:

1. A packaging material comprising:
a first outer layer comprising cellulose fibers and having a first oxygen transmission rate (OTR);
a second outer layer comprising cellulose fibers and having a second (OTR); and
a barrier layer comprising cellulose fibers arranged between the first and second outer layers and having a third OTR that is less than each of the first and second OTRs of the first and second outer layers.

2. The packaging material of claim 1, wherein
each of the first and second OTRs of the first and second outer layers is greater than 1,000 cm³/m²/day; and
the OTR of the barrier layer is 100 cm³/m²/day or less.

3. The packaging material of claim 2, wherein the barrier layer comprises at least one of microfibrillated cellulose (MFC) and cellulose nanofibril (CNF).

4. The packaging material of claim 3, wherein the MFC and/or CNF comprises cellulose fibers having at least one of a diameter and a length dimension of less than 100 nm.

5. The packaging material of claim 4, wherein the MFC and/or CNF comprises cellulose fibers with both diameter and length dimensions of less than 100 nm.

6. The packaging material of claim 3, wherein the barrier layer has a basis weight of between 3 to 8 GSM.

7. The packaging material of claim 6, wherein the barrier layer has a basis weight of 5 GSM.

8. The packaging material of claim 6, wherein each of the first and second outer layers has a basis weight that is at least twice the basis weight of the barrier layer.

9. The packaging material of claim 8, wherein each of the first and second outer layers has a basis weight that is at least 15 GSM.

10. The packaging material of claim 8, wherein each of the first and second outer layers is at least twice as thick as the barrier layer.

11. The packaging material of claim 2, wherein the barrier layer is formed from a foamed MFC and/or CNF product comprising a volume of MFC and/or CNF incorporated into a volume of foam upstream of a paper machine headbox.

12. The packaging material of claim 11, wherein the foamed MFC and/or CNF product is a reaction product of a cationic polymer and a nanofiber slurry.

13. A method of forming a packaging material comprising:
delivering a first cellulose-based feedstock to a wet end of a paper machine;
delivering a second cellulose-based feedstock to the wet end of the paper machine;
delivering a cellulose-based nanofiber slurry as a third cellulose-based feedstock to the wet end of the paper machine;
forming a first outer paper layer with an oxygen transmission rate (OTR) of greater than 100 cm³/m²/day from the first cellulose-based feedstock;
forming a second outer paper layer with an OTR of greater than 100 cm³/m²/day from the second cellulose-based feedstock; and
forming a barrier layer with an OTR of less than 100 cm³/m²/day between the first and second outer paper layers from the third cellulose-based feedstock.

14. The method of claim 13, further comprising:
creating a foamed microfibrillated cellulose (MFC) and/or cellulose nanofibril (CNF) product upstream of the paper machine wet end;
delivering the foamed MFC and/or CNF product to the wet end of the paper machine as the third cellulose-based feedstock.

15. The method of claim 14, further comprising:
adding a cationic polymer to the nanofiber slurry upstream of the wet end of the paper machine.

16. The method of claim 14, further comprising combing the barrier layer with each of the first and second outer paper layers including:
physically entangling fibers of the MFC and/or CNF with cellulose fibers of each of the first and second outer paper layers; and
bonding fibers of the MFC and/or CNF with cellulose fibers of each of the first and second outer paper layers by way of hydrogen bonding of respective hydroxyl groups of the MFC and/or CNF of the barrier layer with the cellulose fibers of each of the first and second outer paper layers.
